(19) United States
(12) Patent Application Publication
(10) Pub. No.: US 2025/0030228 A1
(43) Pub. Date: Jan. 23, 2025

(54) HOUSING AND CABLE CLAMP AND DEVICE FOR DETERMINING AND/OR MONITORING A PROCESS VARIABLE OF A MEDIUM

(71) Applicant: Endress+Hauser SE+Co. KG, Maulburg (DE)

(72) Inventors: Andreas Kaiser, Kaisten AG (CH); Florian Spitz, Görwihl (DE)

(21) Appl. No.: 18/779,655

(22) Filed: Jul. 22, 2024

(30) Foreign Application Priority Data
Jul. 21, 2023 (DE) 10 2023 119 351.1

(51) Int. Cl. H02G 3/06; G01F 23/284

(52) U.S. Cl. CPC H02G 3/0658; G01F 23/284

(57) ABSTRACT

The present disclosure resides in a housing with a cable clamp. A lateral, traversing opening laterally opens a cable passageway. Three claws are located at different heights along a longitudinal axis, wherein two claws are located in a same angular range around the longitudinal axis. One claw is located in another angular range and at a height between the two other claws. Furthermore, the present disclosure relates to a device for determining and/or monitoring a process variable of a medium as well as to a cable clamp.

### CROSS-REFERENCE TO RELATED APPLICATION

The present application is related to and claims the priority benefit of German Patent Application No. 10 2023 119 351.1, filed on Jul. 21, 2023, the entire contents of which are incorporated herein by reference.

### TECHNICAL FIELD

The present disclosure relates to a housing. Furthermore, the present disclosure relates to a device for determining and/or monitoring a process variable of a medium. Additionally, the present disclosure relates to a cable clamp.

### BACKGROUND

Cables for measuring devices are used, for example, for electrical current supply and/or data transmission. For the securing the cables, e.g. in housings, attention must be paid to sufficient affixing and strain relief. Known to be used for such purpose are e.g. hose clips. Projections on the clips are referred to, in such case, as ears. Thus, for example, two-ear clips are used. Disadvantageous in such case is that the cable needs to be led through the clip. In the case of cables having a soft jacket material, such clips can even not function.

### SUMMARY

An object of the present disclosure is to provide a reliable strain relief not limited to special cable types.

The present disclosure solves the object by a housing with a cable clamp, wherein the cable clamp has at least one longitudinal axis, a cable passageway, a lateral, traversing opening, and three claws, wherein the cable passageway extends along the longitudinal axis, wherein the opening laterally opens the cable passageway, wherein the three claws are located at different heights along the longitudinal axis, wherein two of the three claws are so arranged that they are located, at least partially, preferably completely, in a same angular range around the longitudinal axis, and wherein the three claws are so arranged that one claw is located, at least partially, preferably completely, in another angular range around the longitudinal axis than the two other claws and along the longitudinal axis at a height between the two other claws.

The housing of the present disclosure enables connection with a cable and includes a cable clamp. The cable clamp is, in such case, preferably a separate component, which is introducible, or introduced, into the housing. The function of the cable clamp is to assure a cable strain relief. The cable clamp includes, besides a lateral, preferably cable clamp completely traversing opening, a cable passageway. The lateral opening enables introduction of the cable laterally into the cable passageway, thus, without having to lead the cable through the cable passageway. The cable clamp can, thus, be applied on the cable at any position.

For affixing and for strain relief, at least three claws are present, which protrude into the cable passageway and can act on the cable. The claws are located at different heights along a longitudinal axis of the cable clamp and, consequently, also along the cable passageway, which extends along the longitudinal axis. Two claws are arranged spaced, at least partially, from one another along the longitudinal axis, since they are located, at least partially, in a shared angular range. The third claw is located at a height between the two other claws and is located, at least partially, outside of the angular range of the two other claws. The third claw lies, thus, along the longitudinal axis between the two other claws and is located, at least partially, outside of the radial sections around the longitudinal axis, in which the two other claws are located. The claws in the mounted state hold the cable via static friction.

Extensive testing has shown that strain relief is safely provided even in the case of cables, whose jacket is made of a soft material, such as e.g. PVC.

In an embodiment, the one claw is displaced from the other two claws by essentially 180° around the longitudinal axis. In this embodiment, the one claw lies opposite the two other claws.

In an embodiment, the two claws, which are arranged above one another, are located largely in a common angular range.

In an alternative or supplementing embodiment, the angular regions of the two claws and of the third claw are completely disjoint.

An embodiment of the housing provides that the cable clamp is composed, at least partially, of a thermoplastic plastic. In an embodiment, the cable clamp is composed completely of a thermoplastic plastic. In an embodiment, the material of the cable clamp is a polycarbonate.

An embodiment of the housing provides that the cable clamp further includes a spring element, and the spring element is so embodied and arranged that the cable clamp is elastically deformable. In this embodiment, it is provided that an introduction and securement of the cable clamp in the housing occurs as simply and reliably as possible. The spring element enables a deformation of the cable clamp, by which the cable clamp can be placed at a desired site in the housing. When the cable clamp is in the desired position, then the spring element at least partially removes the elastic deformation and the cable clamp is e.g. so relaxed that it becomes secured in the housing e.g. by gripping behind structural elements of the housing.

The spring element is in an embodiment provided as a bridge-preferably between two openings in the cable clamp. There is, thus, produced in a region a targeted material weakening, e.g. by removing material of the cable clamp. The cable clamp can, in such case, be embodied as a single part or a plurality of parts.

An embodiment of the housing provides that the spring element and the opening are diametrally opposite one another.

An embodiment of the housing provides that the claws have, in each case, an areal, essentially curvature free, front face and a thereon following chamfering section. Preferably, the front face is, in each case, so embodied that the cable comes in contact with a relatively sharp edge. The front faces are planarly embodied. Bordering on the front face, in each case, is a section, which extends with a chamfer in a direction, preferably along the longitudinal axis, upwardly or downwardly. The edge in an embodiment is located along the longitudinal axis below the front face, which is located below the chamfering section. In this way, the cable comes in contact, firstly, with the edge, then with the front face and, finally, with the chamfering section.

An embodiment of the housing provides that the chamfering sections of the three claws extend, in each case, in a common direction along the longitudinal axis. The sections of the three claws extend, thus, either all upwardly or downwardly. In this way, all three claws act as barbs opposing a force acting in one direction.

An embodiment of the housing provides that the three claws have, in each case, an insert section widening in the direction of the opening. The outwardly widening, and, thus, inwardly tapered in the direction of the cable passageway, insert sections simplify introduction of the cable.

An embodiment of the housing provides that the cable clamp further includes an outside, and the outside is essentially conically tapered.

Another embodiment provides that the housing further includes a seat for the cable clamp, and the seat has, at least partially, a conically tapered contour. The conical contour exerts a radial squeezing on the cable clamp. This implements the introduction of the cable clamp. The seat has, in such case, in an embodiment, a plurality of parts, wherein only the parts (or, alternatively, segments) have the conical contour. Other parts or sections are so embodied that no contact with the cable clamp and these other sections results upon introduction of the cable clamp into the housing.

In an additional embodiment, the introduction of the cable clamp is facilitated, in that a conically tapered outside of the cable clamp and a conically tapered seat of the housing are present.

An embodiment of the housing provides that the cable clamp further includes a bearing collar and a securement collar, that the bearing collar and the securement collars extend out from the longitudinal axis, and that the seat and the cable clamp are so embodied and adapted to one another that the bearing collar and the securement collar lie in a mounted state of the cable clamp at ends of the seat. In this embodiment, the seat and the cable clamp are so matched with one another that the cable clamp with a bearing collar and a securement collar extends beyond the seat, when the cable clamp is its end position in the housing. The bearing collar and the securement collar extend beyond the seat, thus, preferably so far outwards that a securement action results. Conversely, the separation between bearing collar and securement collar corresponds to the sections of the housing, which are gripped behind by the cable clamp in the mounted state.

An embodiment of the housing provides that the housing further includes a sealing element and a lid element. The sealing element is, for example, a cable sealing plug. The function of the sealing element is to seal the housing. The lid element is, for example, a snap disk. The lid element provides a closure or closing off of the housing from the environment.

Furthermore, the present disclosure achieves the object by a device for determining and/or monitoring a process variable of a medium, wherein the device comprises a housing according to one of the preceding or following embodiments. The explanations for the housing and its embodiments hold correspondingly also for the device comprising the housing. Therefore, such is not repeated. The medium is e.g. a liquid, a gas or a bulk good. The process variable is e.g. a fill level in a container, a flow, a pH value or a temperature.

Additionally, the present disclosure achieves the object by a cable clamp having a longitudinal axis, a cable passageway, a lateral, traversing opening and three claws, wherein the cable passageway extends along the longitudinal axis, wherein the opening laterally opens the cable passageway, wherein the three claws are located at different heights along the longitudinal axis, wherein two of the three claws are so arranged that they are located, at least partially, preferably completely, in a same angular range around the longitudinal axis, and wherein the three claws are so arranged that one claw is located, at least partially, preferably completely, in another angular range around the longitudinal axis than the two other claws and along the longitudinal axis at a height between the two other claws. The cable clamp assures a strain relief for a cable essentially independently of the character of a jacket of the cable. The above and the following discussed embodiments of the cable clamp hold also for this teaching of the present disclosure and vice versa. Therefore, a repetition is omitted.

### BRIEF DESCRIPTION OF THE DRAWINGS

The present disclosure will now be explained in greater detail based on the appended drawing, the figures of which show as follows:

FIG. 1 shows schematically, a measuring setup,

FIG. 2 shows a perspective view of a cable clamp,

FIG. 3 shows the cable clamp of FIG. 2 from the side,

FIG. 4 shows the outside of the cable clamp of FIG. 2,

FIG. 5 shows a partially sectioned, perspective view of the housing,

FIG. 6 shows a top view of the housing with lid, and

FIG. 7 shows a section of the housing in the mounted state.

### DETAILED DESCRIPTION

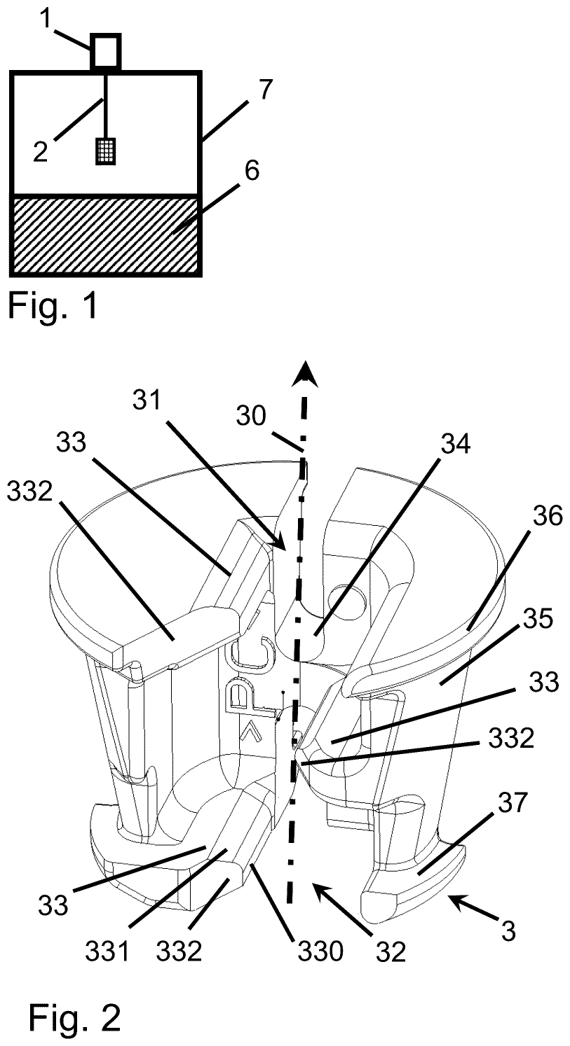

FIG. 1 shows schematically how the fill level of medium 6 in a container 7 is measured with a device. For such purpose, there is located in the container 7 on the lower end of the cable 2 a measuring head, which radiates microwaves and receives such back after their reflection on the surface of the medium 6. The fill level is obtained from the travel time of the waves. The housing 1 used for this is described in greater detail in the following.

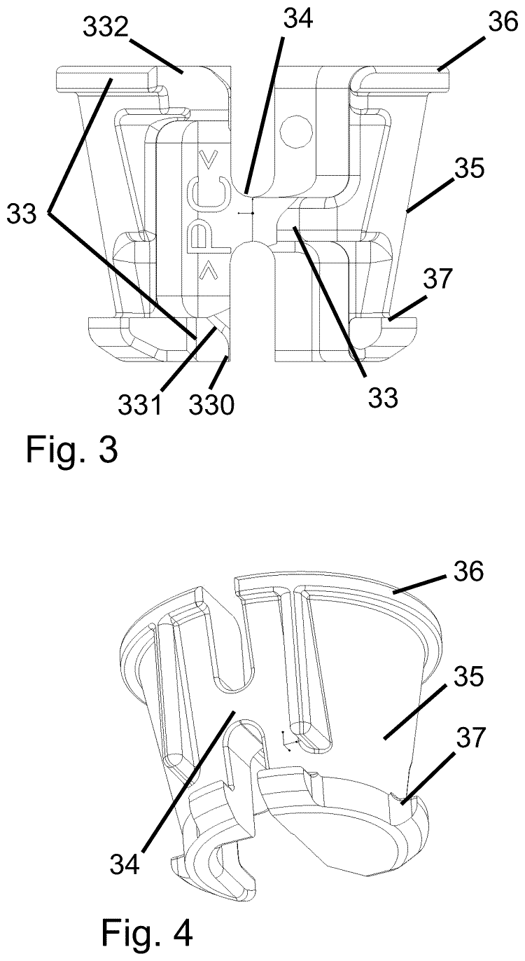

FIG. 2 and FIG. 3 show the cable clamp 3, which embraces the cable 2 in the housing 1 and contributes to its securement. The following description refers to both figures.

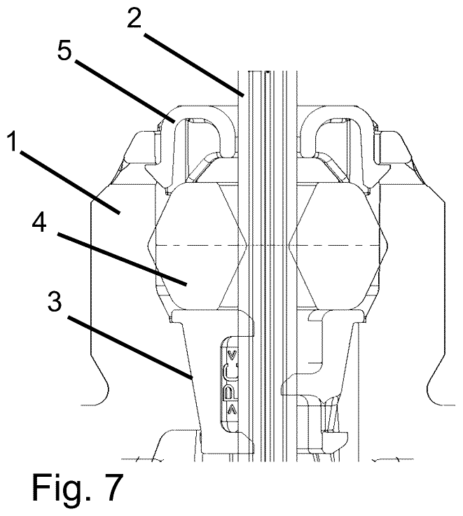

Extending along a longitudinal axis 30 is a cable passageway 31, in which the cable 2 is located in the mounted state (compare FIG. 7). Since the cable passageway 31 is accessible via the opening 32 arranged laterally on the cable clamp 3 and traversing the cable clamp 3, the cable 2 can be easily placed sideways into the cable clamp for the mounting. Thus, no threading of the cable 2 through the cable clamp 3 is necessary.

Three claws 33 serve for holding the cable 2 in the cable clamp 3. The three claws 33 are situated at three different heights along the longitudinal axis 30. Additionally, the three claws 33 are located in different angular ranges around the longitudinal axis 30. In the illustrated example of an embodiment, two claws 33 are located in the same angular range (in both figures, these are located on the left side and, in the illustrated embodiment, are differently embodied. These claws lie, thus, on top of one another. The third claw 33 is located along the longitudinal axis 30 between the other two claws 33 and in another angular range (in such case, located in the drawing on the right side. The one claw 33 and the pair of claws 33 lie, in such case, on opposite sides of the axis.

The claws 33 protrude, in each case as collar sections, into the cable passageway 31 and effect therewith in the mounted state, in each case, a direction change of the cable 2, in order to achieve its clamping. Toward the opening 32 the claws 33 end, in each case, with an insert section 332, which is embodied as an area inclined toward the cable passageway 31. In this way, the introduction of the cable 2 is further facilitated.

For the actual clamping, the claws 33 exhibit relatively sharp edges at their front faces 330. The front faces 330 are essentially planar and, not rounded or curved areas. Closing on the front faces 330 are, in each case, chamfered sections 331—here, in each case, with a 45°-angle. The chamfering is located here, in each case, on the upper sides of the claws 33.

Located diametrally opposite the opening 32 is a spring element 34, which is formed by a bridge. For such purpose, a part of the wall of the cable clamp 3 is removed, except for the bridge, which is located about at mid-height of the cable clamp 3. In this way, virtually two halves of the cable clamp 3 result, which are monolithically connected together via the bridge. The bridge enables by its small spatial extent that the cable clamp 3 can be elastically deformed during the mounting.

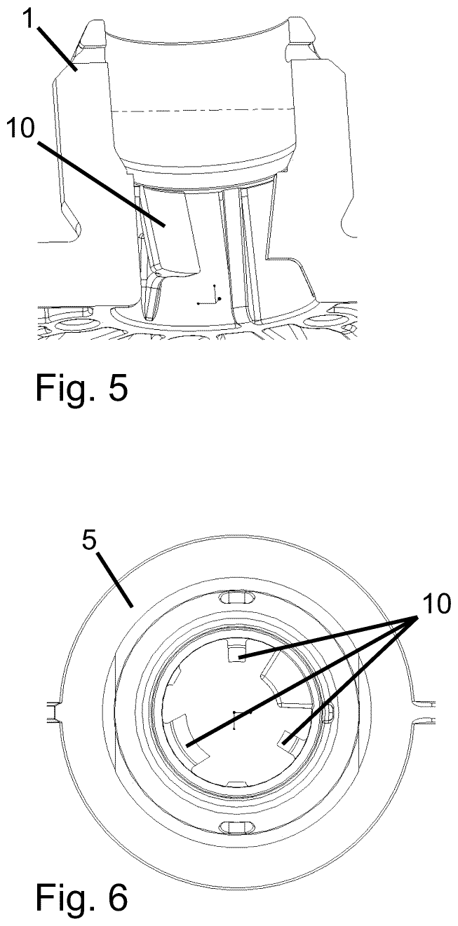

Arranged on the two end regions of the cable clamp 3 are the bearing collar 36 and the securement collar 37, which extend, in each case, outwardly from the longitudinal axis 30 and, thus, also outwardly from the cable passageway 31. In the mounted state, collars 36, 37, respectively, lie on a support of the housing 1 and grip behind an undercut of the same. In this way, there results an axial securement of the cable clamp 3 in the housing 1 (compare FIG. 7). The exterior wall 35 has a conically tapered shape, which matches the form of a seat 10 of the housing 1 (compare FIGS. 5 to 7).

FIG. 4 shows the exterior wall 35 of the cable clamp 3 in the region of the spring element 34. Shown are two laterally flanking structures extending along the longitudinal axis 30 and acting as twist-preventers in the mounted state in the seat of the housing 1. The bearing collar 36 is complete except for the region above the spring element 34. The securement collar 37 is similarly interrupted. This has the advantage that the securement collar 37 can be more easily compressed during introduction into the seat 10 of the housing 1 and then more easily rebound in diameter at the bottom of the seat 10. Furthermore, the interruptions have the advantage of material and weight savings. The number of parts of the securement collar 37 resulting from the interruptions equals in an embodiment the number of components or segments of the housing 1 serving as seat 10 for the cable clamp 3. The placements are, in such case, matched to one another.

FIG. 5 shows the section of the housing 1, into which the cable clamp 3 is introduced. Seat 10 is provided in the form of an internally contoured recess, which conically tapers. The conical wall sections have on top a bearing area and below an undercut. If, consequently, the cable clamp 3 is introduced from above into the seat 10 and drawn or pressed downwards, then the cable clamp 3 is ever more compressed, until the bearing collar 36 comes to rest on the upper bearing area. If such a relative arrangement between cable clamp 3 and seat 10 is achieved, then also the securement collar 37 has reached the bottom of the seat 10 and grips behind the lower end of the seat 10. FIG. 5 shows only a conical segment of the multi-part seat 10. The side of the segment is cutout, such that the cable clamp 3 does not bump against anything when being laterally inserted.

FIG. 6 is a top view of the housing 1 without cable, which would be centrally located, and without cable clamp. The lid element 5 has a central passageway to accommodate the cable. Into this passageway—and therewith, when the cable clamp 3 is installed, into its cable passageway 31—reach the three segments of the seat 10.

FIG. 7 shows an assembled housing 1 and cable 2. Cable 2 is held in the cable clamp 3, whose three claws 33 contact and press into the cable jacket. The cable clamp 3 is secured to the housing 1 by the two collars 36, 37. Above the cable clamp 3 is an annular sealing element 4, and, in addition, the lid element 5, which is embodied as a snap element.

1. A housing with a cable clamp,
wherein the cable clamp has at least one longitudinal axis, a cable passageway, a lateral, traversing opening and three claws,
wherein the cable passageway extends along the longitudinal axis,
wherein the opening laterally opens the cable passageway,
wherein the three claws are located at different heights along the longitudinal axis,
wherein two of the three claws are so arranged that they are located in a same angular range around the longitudinal axis, and
wherein the three claws are so arranged that one claw is located in another angular range around the longitudinal axis than the two other claws and along the longitudinal axis at a height between the two other claws.

2. The housing as claimed in claim 1,
wherein the cable clamp is composed of a thermoplastic plastic.

3. The housing as claimed in claim 1,
wherein the cable clamp further includes a spring element, and wherein the spring element is so embodied and arranged that the cable clamp is elastically deformable.

4. The housing as claimed in claim 3,
wherein the spring element and the opening are diametrally opposite one another.

5. The housing as claimed in claim 4,
wherein the claws have, in each case, an areal front face and a thereon following chamfering section.

6. The housing as claimed in claim 5,
wherein the chamfering sections of the three claws extend, in each case, in a common direction along the longitudinal axis.

7. The housing as claimed in claim 6,
wherein the three claws have, in each case, an insert section widening in the direction of the opening.

8. The housing as claimed in claim 7,
wherein the cable clamp further includes an outside, and wherein the outside is essentially conically tapered.

9. The housing as claimed in claim 8,
wherein the housing further includes a seat for the cable clamp, and wherein the seat has a conically tapered contour.

10. The housing as claimed in claim 9,
wherein the cable clamp further includes a bearing collar and a securement collar, wherein the bearing collar and the securement collar extend out from the longitudinal axis, and
wherein the seat and the cable clamp are so embodied and adapted to one another that the bearing collar and the securement collar lie in a mounted state of the cable clamp on ends of the seat.

11. A device for determining and/or monitoring a process variable of a medium, wherein the device comprises a housing, wherein the housing includes a cable clamp, the housing including a cable clamp,
wherein the cable clamp has at least one longitudinal axis, a cable passageway, a lateral, traversing opening and three claws,
wherein the cable passageway extends along the longitudinal axis,
wherein the opening laterally opens the cable passageway,
wherein the three claws are located at different heights along the longitudinal axis,
wherein two of the three claws are so arranged that they are located in a same angular range around the longitudinal axis, and
wherein the three claws are so arranged that one claw is located in another angular range around the longitudinal axis than the two other claws and along the longitudinal axis at a height between the two other claws.

12. A cable clamp having a longitudinal axis, a cable passageway, a lateral, traversing opening and three claws, wherein the cable passageway extends along the longitudinal axis, wherein the opening laterally opens the cable passageway, wherein the three claws are located at different heights along the longitudinal axis, wherein two of the three claws are so arranged that they are located in a same angular range around the longitudinal axis, and wherein the three claws are so arranged that one claw is located in another angular range around the longitudinal axis than the two other claws and along the longitudinal axis at a height between the two other claws.
